(19) United States
(12) Patent Application Publication
(10) Pub. No.: US 2020/0288628 A1
(43) Pub. Date: Sep. 17, 2020

(54) MACRONUTRIENT COMPOUNDS

(71) Applicant: Ralco Nutrition, Inc., Marshall, MN (US)

(72) Inventors: Richard Dale Lamb, Balaton, MN (US); Michael David Johnson, Balaton, MN (US); Evan Everette Johnson, Balaton, MN (US); Emma Rose Vaske, Marshall, MN (US)

(21) Appl. No.: 16/815,756

(22) Filed: Mar. 11, 2020

Related U.S. Application Data
(60) Provisional application No. 62/816,439, filed on Mar. 11, 2019.

(51) Int. Cl. A01C 1/06

(52) U.S. Cl. CPC A01C 1/06

(57) ABSTRACT

Embodiments of the present disclosure describe seed, soil, or plant treatment compositions comprising a macronutrient source comprising or consisting of a mineral lactate. Embodiments also describe methods of synthesizing a mineral lactate comprising providing a solution of lactic acid in a first vessel; contacting the solution of lactic acid with a mineral precursor to form a reaction solution in which at least a portion of the mineral precursor is dissolved; allowing the reaction to proceed or optionally transferring the reaction solution to a second vessel where the reaction is allowed to proceed; and optionally reducing the solid mineral lactate to a select particle size to obtain a rapidly soluble solid mineral lactate. Embodiments also describe methods of applying a treatment composition to a seed, soil, or a plant, wherein the treatment composition comprises a macronutrient source comprising or consisting of a mineral lactate.

### BACKGROUND

The macronutrients for plant nutrition can be described as belonging to one of two categories: primary macronutrients and secondary macronutrients. The primary macronutrients generally include nitrogen, phosphorus, and potassium (as well as carbon, hydrogen, and oxygen from air and water). The secondary macronutrients generally include calcium, magnesium, and sulfur. The primary and secondary macronutrients are essential for plant growth. However, conventional sources of macronutrients can suffer from low solubility and/or reduced bioavailability due to interactions with other components. Accordingly, it would be desirable to provide highly soluble and bioavailable macronutrient compositions for improving plant growth and health.

### SUMMARY

In general, embodiments of the present disclosure describe seed, soil, or plant treatment compositions comprising soluble macronutrient compounds, methods of synthesizing soluble macronutrient compounds, methods of applying seed, soil, or plant treatment compositions, and the like.

Embodiments of the present disclosure describe seed, soil, or plant treatment compositions comprising a macronutrient source comprising or consisting of a mineral lactate, wherein the mineral lactate is selected from magnesium lactate, calcium lactate, potassium lactate, and ammonium lactate.

Embodiments of the present disclosure describe methods of synthesizing a mineral lactate comprising providing a solution of lactic acid in a first vessel, wherein the solution is provided at or below a threshold temperature; contacting the solution of lactic acid with a mineral precursor to form a reaction solution in which at least a portion of the mineral precursor is dissolved; allowing the reaction to proceed or optionally transferring the reaction solution to a second vessel where the reaction is allowed to proceed, wherein the reaction produces a solid mineral lactate; and optionally reducing the solid mineral lactate to a select particle size to obtain a rapidly soluble solid mineral lactate.

Embodiments of the present disclosure describe methods of applying a treatment composition to a seed, soil, or a plant, wherein the treatment composition comprises a macronutrient source comprising or consisting of a mineral lactate, wherein the mineral lactate is selected from magnesium lactate, calcium lactate, potassium lactate, and ammonium lactate.

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of synthesizing a solid mineral lactate, according to one or more embodiments of the present disclosure.

FIG. 2 is a flowchart of a method of applying a seed, soil, or plant treatment composition, according to one or more embodiments of the present disclosure.

FIG. 3 is a graphical view of emergence data from soybean studies in which magnesium lactate was applied to foliar, according to one or more embodiments of the present disclosure.

FIG. 4 is a graphical view of 7^{th} trifoliate leaf areas from soybean studies in which magnesium lactate was applied to foliar, according to one or more embodiments of the present disclosure.

FIG. 5 is a graphical view of pod counts from soybean studies in which magnesium lactate was applied to foliar, according to one or more embodiments of the present disclosure.

FIG. 6 is a graphical view of pod weights from soybean studies in which magnesium lactate was applied to foliar, according to one or more embodiments of the present disclosure.

FIG. 7 is a graphical view of total soybean seed weights from soybean studies in which magnesium lactate was applied to foliar, according to one or more embodiments of the present disclosure.

FIG. 8 is a graphical view of average soybean seed weights per pot from soybean studies in which magnesium lactate was applied to foliar, according to one or more embodiments of the present disclosure.

FIG. 9 is a graphical view of average seed weights versus average pod weights from soybean studies in which magnesium lactate was applied to foliar, according to one or more embodiments of the present disclosure.

FIG. 10 is a graphical view of emergence data from soybean studies in which magnesium lactate was applied to foliar, according to one or more embodiments of the present disclosure.

FIG. 11 is a graphical view of height data from soybean studies in which magnesium lactate was applied to foliar, according to one or more embodiments of the present disclosure.

FIG. 12 is a graphical view of stalk diameters from soybean studies in which magnesium lactate was applied to foliar, according to one or more embodiments of the present disclosure.

FIG. 13 is a graphical view of chlorophyll readings from soybean studies in which magnesium lactate was applied to foliar, according to one or more embodiments of the present disclosure.

FIG. 14 is a graphical view of biomasses from soybean studies in which magnesium lactate was applied to foliar, according to one or more embodiments of the present disclosure.

FIG. 15 is a graphical view of yield results from corn studies in which magnesium lactate was applied to foliar, according to one or more embodiments of the present invention.

FIG. 16 is a graphical view of yield results from corn studies in which magnesium lactate was applied to foliar, according to one or more embodiments of the present invention.

FIG. 17 is a graphical view of yield results from corn studies in which magnesium lactate was applied to foliar, according to one or more embodiments of the present invention.

FIG. 18 is a graphical view of yield results from corn studies in which magnesium lactate was applied to foliar, according to one or more embodiments of the present invention.

FIG. 19 is a graphical view of yield results from a second soybean study in which magnesium lactate was applied in furrow, according to one or more embodiments of the present invention.

FIG. 20 is a graphical view of yield results from a second soybean study in which magnesium lactate was applied in furrow, according to one or more embodiments of the present invention.

FIG. 21 is a graphical view of yield results from a second soybean study in which magnesium lactate was applied in furrow, according to one or more embodiments of the present invention.

FIG. 22 is a graphical view of yield results from a second soybean study in which magnesium lactate was applied in furrow, according to one or more embodiments of the present invention.

FIG. 23 is a graphical view of yield results from a third soybean study in which magnesium lactate was applied to foliar, according to one or more embodiments of the present invention.

FIG. 24 is a graphical view of yield results from a third soybean study in which magnesium lactate was applied to foliar, according to one or more embodiments of the present invention.

FIG. 25 is a graphical view of yield results from a third soybean study in which magnesium lactate was applied to foliar, according to one or more embodiments of the present invention.

FIG. 26 is a graphical view of yield results from a third soybean study in which magnesium lactate was applied to foliar, according to one or more embodiments of the present invention.

FIG. 27 is a graphical view of yield results from a third soybean study in which magnesium lactate was applied to foliar, according to one or more embodiments of the present invention.

FIG. 28 is a graphical view of yield results from a third soybean study in which magnesium lactate was applied to foliar, according to one or more embodiments of the present invention.

### DETAILED DESCRIPTION

The present disclosure relates to economical, cost-effective, and efficient methods of synthesizing highly soluble forms of macronutrients in the form of solid mineral lactates. The methods of the present disclosure can synthesize the highly soluble solid mineral lactates with high purity and without producing waste or by-products, or at least without producing them in any appreciable amount. This not only reduces the costs and expenses associated with disposal of waste and/or by-products, but also those costs and expenses associated with the purchase of reagents. Unlike conventional methods, the methods of the present disclosure can be used to synthesize highly soluble solid mineral lactates that have greater bioavailability than other conventional sources of macronutrients and thus are more readily bioavailable.

### Definitions

The terms recited below have been defined as described below. All other terms and phrases in this disclosure shall be construed according to their ordinary meaning as understood by one of skill in the art.

As used herein, “lactic acid” refers to a carboxylic acid having the chemical structural formula of CH₃CH(OH)CO₂H. Lactic acid forms highly soluble chelates with many important minerals.

As used herein, “rapidly soluble” refers to a compound that has been altered to increase solubility in a solvent. Altering may include reducing in size, filtering, screening or chemically reacting. An inorganic mineral compound may be organically chelated such that its solubility changes from insoluble to soluble in a chosen solvent.

As used herein, “solution” refers to a homogeneous or substantially homogeneous mixture of two or more substances, which may be solids, liquids, gases or a combination thereof.

As used herein, “mixture” refers to a combination of two or more substances in physical or chemical contact with one another.

As used herein, “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture, in vitro, or in vivo. Accordingly, treating, tumbling, vibrating, shaking, mixing, and applying are forms of contacting to bring two or more components together.

As used herein, “carrier” refers to a substance that physically or chemically binds or combines with a target or active substance to facilitate the use, storage or application of the target or active substance. Carriers are often inert materials, but can also include non-inert materials when compatible with the target or active substances. Examples of carriers include, but are not limited to, water for compositions that benefit from a liquid carrier, or diatomaceous earth for compositions that benefit from a solid carrier.

Embodiments of the present disclosure describe seed, soil, or plant treatment compositions comprising a macronutrient source. The macronutrient source can comprise or consist of a mineral lactate and/or the macronutrient source can comprise a particle consisting of a mineral lactate. The mineral lactate is typically provided in a highly soluble solid form, such as a solid or rapidly soluble mineral lactate. For example, in an embodiment, the macronutrient source comprises or consists of a solid mineral lactate, or a particle consisting of a solid mineral lactate. In some embodiments, the treatment compositions comprise a macronutrient source associated with or sorbed (e.g., absorbed, adsorbed, or combinations thereof) to a solid carrier. In these embodiments, the macronutrient source is delivered to a seed, soil, or plant via the solid carrier, where it then dissolves or solubilizes. In other embodiments, the treatment compositions comprise a macronutrient source dissolved or solubilized in a liquid carrier, optionally in the presence of one or more other components. In these embodiments, the macronutrient source is dissolved or solubilized and then delivered to a seed, soil, or plant.

The solid mineral lactate can be selected from solid magnesium lactate, solid calcium lactate, solid potassium lactate, and solid ammonium lactate. In an embodiment, the solid mineral lactate is present in hydrated form. The solid mineral lactates can have an average particle size. The average particle size of the solid mineral lactates can range from about 1 μm to about 5 inches. In an embodiment, the average particle size of the solid mineral lactates can range from about 100 μm to about 300 μm. For example, the average particle size can be about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, or about 300 μm. In one embodiment, the average particle size is about 297 μm. In another embodiment, the average particle size is about 250 μm. In another embodiment, the average particle size is about 210 μm. In another embodiment, the average particle size is about 180 μm. Other sizes are possible. These shall not be limiting.

The solid mineral lactates generally have a low amount of impurities. For example, the solid mineral lactates can be about 100% pure or less. In one embodiment, the solid mineral lactates have a purity ranging from about 90% pure to about 99.99% pure. For example, the solid mineral lactates can be about 90% pure, about 91% pure, about 92% pure, about 93% pure, about 94% pure, about 95% pure, about 96% pure, about 97% pure, about 98% pure, about 99% pure, about 99.9% pure, or greater.

The seed, soil, and plant treatment compositions can further comprise one or more of carriers, mineral chelated compounds, mineral salt compounds, fibers, enzymes, pesticides, insecticides, fungicides, and herbicides.

The seed, soil, and plant treatment compositions can further comprise carriers. Carriers are typically inert materials that do not react with the active components of the composition chemically, or bind the active components physically by absorption or adsorption. Liquid carriers may include pure water, such as reverse osmosis water, or other liquids, such as crop oils or surfactants which are compatible with the composition and plant tissue. The composition may be at least about 50% water by weight, at least about 65% water by weight, at least about 75% water by weight, at least about 85% water by weight, or at least about 90% water by weight. In some embodiments, the composition will be about 60% to about 70% water, 80% to about 99% water, about 85% to about 98% water, about 90% to about 95% water, or about 91% to about 94% water.

In some other compositions it is preferable to use solid carriers, such as diatomaceous earth, finely ground limestone (CaCO₃), or magnesium carbonate (MgCO₃). Sugars such as sucrose, maltose, maltodextrin, or dextrose may also be used as solid carriers. In other compositions, it is beneficial to use a combination of solid and liquid carriers.

The seed, soil, or plant treatment compositions may further comprise one or more mineral chelated compounds. A mineral of the mineral chelated compound may include one or more of cobalt, scandium, selenium, titanium, vanadium, manganese, iron, nickel, copper, and zinc. For example, the mineral chelated compound may include one or more of a cobalt chelated compound, a scandium chelated compound, a selenium chelated compound, a titanium chelated compound, a vanadium chelated compound, a manganese chelated compound, an iron chelated compound, a nickel chelated compound, a copper chelated compound, and a zinc chelated compound.

A chelate of the mineral chelated compound may include one or more of lactate, ethylene diamine, ethylenediamine tetraacetate (EDTA), propionate, butyrate, and acetate. For example, the mineral chelated compound may include one or more of a mineral lactate compound, a mineral ethylene diamine compound, a mineral ethylenediamine tetraacetate compound, a mineral propionate compound, a mineral butyrate compound, and a mineral acetate compound.

The seed, soil, or plant treatment composition may further comprise one or more mineral salt compounds. A mineral of the mineral salt may include one or more of cobalt, scandium, selenium, titanium, vanadium, manganese, iron, nickel, copper, zinc, aluminum, tin, and chromium. For example, the mineral salt may include one or more of a cobalt salt compound, a scandium salt compound, a selenium salt compound, a titanium salt compound, a vanadium salt compound, a manganese salt compound, an iron salt compound, a nickel salt compound, a copper salt compound, a zinc salt compound, an aluminum salt compound, a tin salt compound, and a chromium salt compound.

A salt anion of the mineral salt compound may include one or more of bromide, chloride, fluoride, carbonate, hydroxide, nitrate, oxide, phosphate, sulfate, formate, acetate, propionate, butyrate, oxalate, citrate, malate, lactate, or tartrate. For example, the mineral salt compound may include one or more of a mineral bromide compound, a mineral chloride compound, a mineral fluoride compound, a mineral carbonate compound, a mineral hydroxide compound, a mineral nitrate compound, a mineral oxide compound, a mineral phosphate compound, a mineral sulfate compound, a mineral formate compound, a mineral acetate compound, a mineral propionate compound, a mineral butyrate compound, a mineral oxalate compound, a mineral citrate compound, a mineral malate compound, a mineral lactate compound, and a mineral tartrate compound.

The seed, soil, and plant treatment composition may also include a fiber, for example, a fiber that can act as a food source for beneficial bacteria in soil or another growth medium. Fiber can also act as an adherent. Soluble fibers are preferred as they generally enhance product efficacy and stability by keeping less soluble materials in solution or suspension due to their inherent charge and ability to disperse other charged components in solution. Soluble fibers also allow for higher composition-to-seed adhesion in pre-treatment. Fiber content within the composition is adjustable to better maintain less soluble materials in solution or suspension, and to modify composition “stickiness”. Higher fiber content and “stickiness” is often desirable in seed pre-treatments in order to ensure sufficient composition binding to and coverage of the seeds. Fiber content and type can also be modified to control composition-seed adhesion time, and adhesion strength. Because seeds can be pre-treated off-site and must be transported to farms, adhesion strength is important to ensure that pre-treatment compositions do not shake, rub, or fall off the seeds during processing, shipping, storage, or planting. The higher fiber content and overall concentration of pre-treatment compositions in comparison foliar and in-furrow application compositions may increase composition density. Lower fiber content may be preferable for liquid foliar or in-furrow application compositions, which ideally have lower percent solids and viscosities to allow for easier transport and application, and to minimize equipment clogging. Suitable and effective fibers include hemicellulose, for example, the hemicellulose extracted from Larch trees, or larch arabinogalactan. Another example of a suitable fiber is a yucca plant extract, commercially available as Saponix 5000 or BioLiquid 5000. Another example of a suitable fiber is Yucca schidigera.

The seed, soil, and plant treatment composition can further include one or more enzymes, including a blend of enzymes. The enzymes can serve to break down cellulosic material and other material, including stover left on a field after harvest. Useful and beneficial enzymes include enzymes which break down starch, such as amylases, enzymes which break down protein, such as proteases, enzymes which break down fats and lipids, such as lipases, and enzymes which break down cellulosic material, such as cellulases.

The seed, soil, and plant treatment composition can also include one or more compatible pesticides, such as glyphosate. The composition can include many different types of fungicides, which may contain active ingredients including but not limited to: chlorothalonil, copper hydroxide, copper sulfate, mancozeb, flowers of sulfur, cymoxanil, thiabendazole, captan, vinclozolin, maneb, metiram, thiram, ziram, iprodione, fosetyl-aluminum, azoxystrobin, and metalaxyl. The composition can include many different types of insecticides, which may contain active ingredients including but not limited to: aldicarb, acephate, chlorpyrifos, pyrethroids, malathion, carbaryl, sulfuryl fluoride, naled, dicrotophos, phosmet, phorate, diazinon, dimethoate, azinphos-methyl, endosulfan, imidacloprid, and permethrin. The composition can include many different types of herbicides, which may contain active ingredients including but not limited to: diuron, 2-methyl-4-chlorophenoxyacetic acid (MCPA), paraquat, dimethenamid, simazine, trifluralin, propanil, pendimenthalin, metolachlor-S, glyphosate, atrazine, acetochlor, “2,4-D”, methylchlorophenoxypropionic acid (MCPP), pendimethalin, dicamba, pelarganoc acid, triclopyr, monosodium methyl arsenate (MSMA), sethoxydim, quizalofop-P, primisulfuron, imazamox, cyanazine, bromoxylin, s-ethyl dipropylthiocarbamate (EPTC), glufosinate, norflurazon, clomazone, fomesafen, alachlor, diquat, and isoxaflutole.

In one embodiment, the seed, soil, or plant treatment composition comprises a macronutrient source comprising or consisting of magnesium lactate, or a particle consisting of magnesium lactate. In an embodiment, the magnesium lactate is solid magnesium lactate. Magnesium is the core metal ion in the plant's chlorophyll molecule and therefore helps convert sunlight into energy that the plant can use through photosynthesis. The seed, soil, or plant treatment composition described in this embodiment can be applied to improve the efficiency with which the plant builds chlorophyll, among other things. This, for example, was observed when the treatment compositions were applied foliar in sparingly small quantities to plants, optionally early in their growth stage.

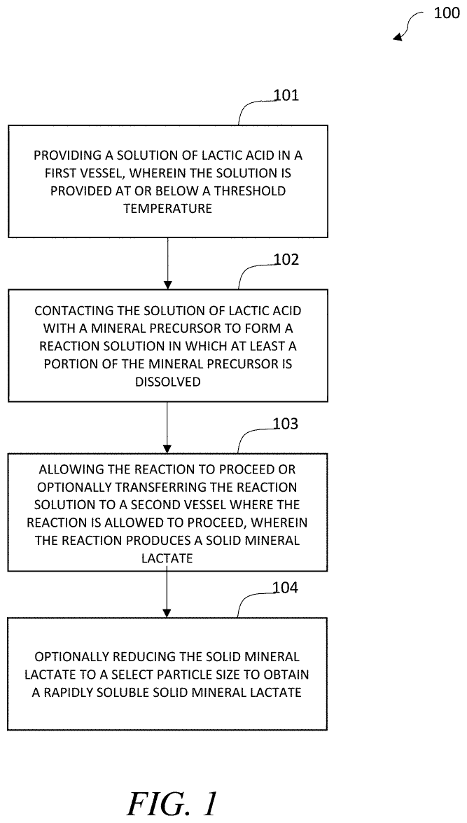

FIG. 1 is a flowchart of a method of synthesizing a solid mineral lactate, according to one or more embodiments of the present disclosure. As shown in FIG. 1, the method 100 of synthesizing a solid mineral lactate can comprise providing 101 a solution of lactic acid in a first vessel, wherein the solution is provided at or below a threshold temperature; contacting 102 the solution of lactic acid with a mineral precursor to form a reaction solution in which at least a portion of the mineral precursor is dissolved; allowing the reaction to proceed or optionally transferring 103 the reaction solution to a second vessel where the reaction is allowed to proceed, wherein the reaction produces a solid mineral lactate; and optionally reducing 104 the solid mineral lactate to a select particle size to obtain a rapidly soluble solid mineral lactate.

The step 101 includes providing a solution of lactic acid in a first vessel, wherein the solution is at or below a threshold temperature. The solution of lactic acid can optionally further comprise other species, such as water. For example, in one embodiment, about 88% of the solution is lactic acid and about 12% is water. In an embodiment, the providing 101 can proceed by adding a solution of lactic acid to a first vessel or pouring a solution of lactic acid into a first vessel. The first vessel is not particularly limited and can include, for example, a mixing tank or a reaction vessel, among other types. The providing 101 can be performed while the solution of lactic acid is at or below a threshold temperature. The solution of lactic acid can be heated or cooled, depending on its initial or starting temperature, to a temperature at or below the threshold temperature. For example, in an embodiment, the solution of lactic acid is cooled such that it is at or below the threshold temperature. In an embodiment, the solution of lactic acid is heated such that it is at or below the threshold temperature.

The threshold temperature of a particular reaction system can vary depending on the species involved in the reaction and the reaction conditions, among other things. In some embodiments, the threshold temperature can be about 100° F. or less. For example, the threshold temperature can be about 100° F. or less, about 95° F. or less, about 90° F. or less, about 85° F. or less, about 80° F. or less, about 75° F. or less, about 70° F. or less, about 65° F. or less, about 60° F. or less, about 55° F. or less, about 50° F. or less, about 45° F. or less, about 40° F. or less, about 35° F. or less, about 30° F. or less, or any increment thereof.

The step 102 includes contacting the solution of lactic acid with a mineral precursor, optionally under stirring, to form a reaction solution in which at least a portion of the mineral precursor is dissolved. In a typical case, the contacting proceeds by bringing the solution of lactic acid and mineral precursor into physical contact, or immediate or close proximity—for example, by adding the mineral precursor to the solution of lactic acid. The contacting is generally sufficient to dissolve at least a portion of the mineral precursor in the solution of lactic acid. It can be desirable for the contacting to proceed until the mineral precursor is substantially or completely dissolved in the lactic acid. Accordingly, in some embodiments, the contacting can proceed for a duration sufficient to substantially or completely dissolve the mineral precursor in the lactic acid. In an embodiment, the contacting can optionally be performed with stirring or mixing in order to promote and/or facilitate the dissolving of the mineral precursor in the solution of lactic acid. The stirring can reduce the duration of the contacting that is required to substantially or completely dissolve the mineral precursor in the solution of lactic acid.

The mineral precursor can include any mineral compound (e.g., organic or inorganic salt or chelate, such as an inorganic mineral compound, etc.) capable of dissolving or being solubilized in the solution of lactic acid. For example, the mineral precursor can include one or more of magnesium, calcium, potassium, and nitrogen. In addition, the mineral precursor can be selected from oxides, carbonates, hydroxides, chlorides, bromides, nitrates, citrates, formates, acetates, gluconates, ascorbates, glycinates, sulfates, and combinations thereof. The quality of the mineral lactate produced according to the methods of the present disclosure can be affected by the purity and/or particle size of the mineral precursor. Accordingly, it can be desirable to use mineral precursors having a low concentration of impurities and/or characterized by a fine particle size. For example, in an embodiment, the mineral precursor can have a percent purity of about 90% or greater, about 91% or greater, about 92% or greater, about 93% or greater, about 94% or greater, about 95% or greater, about 96% or greater, about 97% or greater, about 98% or greater, about 99% or greater, or any increment thereof.

The molar ratio of lactic acid to mineral precursor can be about 1:1 or greater. For example, in an embodiment, the molar ratio of lactic acid to mineral precursor is about 2:1, about 3:1, about 4:1, about 5:1, about 6:1, about 7:1, about 8:1, about 9:1, or about 10:1. In one embodiment, the molar ratio of lactic acid to mineral precursor is about 2:1. The lactic acid content can be about 60% to about 80% of the mixture by weight. The mineral precursor can be about 20% to about 40% of the mixture by weight. In an embodiment, the mixture may have a lactic acid content of about 62% to about 76% by weight of the mixture and a mineral precursor content of about 24% to about 38% by weight of the mixture.

In an embodiment, the first vessel may optionally be agitated, such as by vibrating, shaking, turning, or spinning Water can be added to the first vessel before, during, or after the contacting of the solution of lactic acid with the mineral precursor. Upon forming the reaction solution, the reaction may be allowed to proceed (e.g., reacted over a period of time) or the step 103 may be performed.

The step 103 includes optionally transferring the reaction solution to a second vessel, or mold (which can be of varying shapes or sizes, such that the solid mineral lactate product can be easily handled and transported), where the reaction is allowed to proceed, wherein the reaction produces solid mineral lactate. Where performed, the transferring step 103 is typically performed prior to the formation of the solid mineral lactate or prior to it substantially solidifying. The transferring step is optional. For example, in an embodiment, the first vessel may be one in which access to the solid mineral lactate product, if the reaction were allowed to proceed therein, would be limited or difficult to remove therefrom, or the first vessel may be appropriate for releasing water vapor or steam formed as a result of the reaction. Accordingly, in embodiments in which such a first vessel is used, it may be desirable to transfer the reaction solution to a second vessel where the reaction is allowed to proceed because the second vessel provides ease of access to the solid mineral lactate product relative to the first vessel. In other embodiments, the first vessel and the second vessel are the same, or the first vessel provides sufficient access to the solid mineral lactate product and/or permits appropriate release of water vapor or steam, and thus, the reaction is allowed to proceed in the first vessel without performing the transferring step 103.

The transferring step 103 is typically performed while the reaction solution is at or below the threshold temperature. While not wishing to be bound to a theory, it is believed that the threshold temperature is about the temperature at which the reaction rapidly proceeds to completion. For example, upon reaching the threshold temperature, the reaction can proceed very rapidly to completion (e.g., evidenced by formation of the solid mineral lactate product), such as, within about 5 sec, or even about 3 sec. In addition, the reaction can be characterized as an exothermic reaction. The contacting between the mineral precursor and solution of lactic acid can cause the resulting reaction solution to gradually or steadily increase in temperature (e.g., at least until the threshold temperature is reached at which point the reaction proceeds very rapidly). The increase in temperature of the reaction solution can result in a corresponding increase in reaction rate. It thus may be desirable to perform step 103 while the reaction solution is at or below the threshold temperature to permit the reaction solution to be transferred from the first vessel to the second vessel, where it is allowed to proceed, prior to forming the solid mineral lactate or at least significant amounts thereof.

The reaction can be allowed to proceed in the first vessel or the second vessel as described above. In many embodiments, as discussed above, the act of contacting and/or mixing can be sufficient to promote the reaction (e.g., by increasing a temperature of the reaction solution). In other words, the reaction can be initiated based solely on the contact between the lactic acid and mineral precursor, optionally after the addition of water. In other embodiments, the reaction solution may require heating to increase a temperature of the reaction solution and thus promote the reaction. Once the reaction solution reaches the threshold temperature, the reaction can rapidly proceed to completion, as evidenced by the release and/or evolution of gases, such as water vapor, steam, and/or carbon dioxide, and the formation of the solid mineral lactate. The resulting solid mineral lactate can be in the form of a porous or non-porous solid. In most cases, the reaction advantageously proceeds without producing any waste or by-products requiring proper disposal, since water vapor and/or steam, and optionally carbon dioxide, can simply be released into the atmosphere or a hood. In this way, the methods described herein are highly efficient and economical in that the materials can be substantially or completely consumed to produce the solid mineral lactate through a reaction that does not produce any waste or by-products that must be properly disposed of. In addition, no reflux process is needed or desired, as often used conventionally with regard to related reactions. All by-products may be passively and naturally removed, without the need for solvent or refluxing. Carbon dioxide and water may be released into the atmosphere, for example.

The step 104 includes optionally reducing the solid mineral lactate to a particle size to obtain a rapidly soluble mineral lactate. For example, in an embodiment, the solid mineral lactate may be removed from the first vessel or the second vessel or molds and placed in a “de-lumper” or single- or double-shaft disintegrator or crusher, which may reduce the size of the compound to small particles. The particles may be about 1 to about 2 inches in size, for example. The small particles may then be further reduced in size, such as, by being contacted with a mill (i.e., hammer mill or roller mill). The small particles may then be reduced to a fine powder. Reducing the solid mineral lactate to a fine powder may increase its solubility, providing rapidly soluble solid mineral lactate. After contacting with a mill, the particles may be screened to further separate larger particles from smaller ones. Any larger particles may be placed back in the mill for further reduction in size. Screening may include filtering with a mesh. The mesh size may be about 50 to about 70 or about 50, about 60 or about 70 size mesh. The mesh size may less than 50 for example.

The solid mineral lactate or rapidly soluble solid mineral lactate may be further contacted with a carrier. The carrier may be a dry substrate or a liquid carrier, for example. The carrier may include one or more of diatomaceous earth, calcium carbonate, limestone, sugars, dextrose, water, ground corn cobs, and starch.

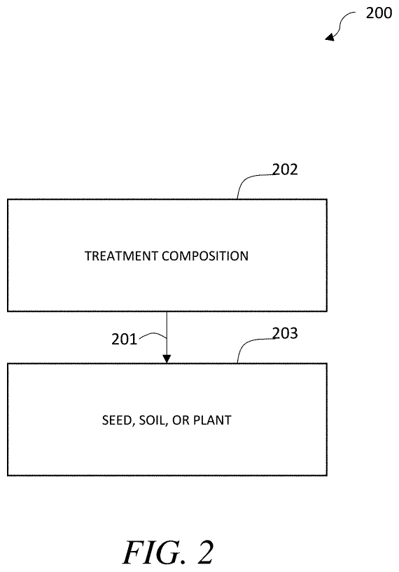

FIG. 2 is a flowchart of a method of applying a seed, soil, or plant treatment composition, according to one or more embodiments of the present disclosure. As shown in FIG. 2, the method 200 can comprise applying 201 a treatment composition 202 to a seed, soil, or a plant 203. The treatment composition 202 can include any of the seed, soil, or plant treatment compositions of the present disclosure. For example, in an embodiment, the treatment composition 202 comprises a macronutrient source consisting of a solid mineral lactate, wherein the mineral lactate is selected from magnesium lactate, calcium lactate, potassium lactate, and ammonium lactate.

The applying 201 is not particularly limited. For example, in an embodiment, the applying can include one or more of applying to foliar, as seed treatments, seed pre-treatments, broadcasting on soil, tilling in soil, in-furrow, spraying, planting in a seed mix, and planting in or mixing with a fertilizer mix, among other things. The treatment compositions can be applied to lawns, gardens, pastures, and fields, among other things. Lawn, garden, pasture or field may include farming land, sporting fields and golf courses, for example. Pasture or field may include a harvested field, bailed field, or field or pasture with crops cut. Applying may also include applying while the crop is harvested or after the crop is harvested. Applying may increase growth in a plant. Applying may include applying the compound in an amount between about 1 to about 100 ppm or between about 1 to about 1000 ppm, for example. The compound may also be used as a benefit to any microflora, enzyme or biological industrial product, for example. Applying may strengthen a root system of a plant.

In one embodiment, the applying includes applying the treatment composition in proximity or in contact with one or more seeds in-furrow. In order to save a farmer time and increase efficiency, one or more treatment compositions can be simultaneously or near-simultaneously placed in-furrow during planting. In-furrow fertilizers can be applied within proximity to a seed or in contact with a seed to promote more vigorous seedling growth by providing immediate nutrient supply to the plant roots. Proximity of in furrow fertilizer to seeds is determined based fertilizer compositions, such as ammonia and salt content that may be toxic to young seedlings. Soil type can also affect in-furrow fertilization efficacy as dryer, sandier soils can exacerbate root zone drying. Maintaining higher moisture content in soil can improve crop response to in-furrow fertilization by alleviating the effects of salt and ammonia. In addition to in-furrow, the treatment composition can be introduced in a side-dress application, tilled in soil as a soil surface application, and combinations thereof. A treatment composition including yeast extract is an example of a treatment composition that can be placed in-furrow with a plant seed without risk or harm or incompatibility with the seeds or proximate chemical treatments. In-furrow application compositions can be solids, homogenous liquids, or heterogeneous slurries. Liquid or slurry application compositions may be preferable as they can be applied using common agricultural sprayers and other like equipment. In many embodiments, the treatment compositions are provided in liquid form.

In another embodiment, the applying includes applying the treatment compositions to one or more seeds prior to planting, as in a seed pre-treatment. Seed pre-treatments can be applied as dusts, but are often homogenous solutions or heterogenous slurries or suspensions. Seed treatment or pretreatment 406 can be accomplished within a seed bag or by mechanical means, such as in a tumbler. The one or more seeds can be agitated after applying 204. Agitating can include tumbling, vibrating, mixing, shaking, and combinations thereof. The applying 204 can be accomplished by spraying, pouring or other means of contacting the treatment composition and seeds. Applying 204 a treatment composition can be performed at an end amount of about 4-5 grams/acre, about 2-5 gms/a, about 5-35 gms/a, about 25-70 gms/a, about 45-95 gms/a, about 75-140 gms/a, about 100-500 gms/a or about 5-5000 gms/a, for example. Seed pre-treatment can be carried out at an off-site facility, on-site at the farm, or on-board planting equipment immediately prior to planting.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### Example 1

### Magnesium Lactate Increased Soybean and Corn Yields

The use of magnesium (Mg) in agricultural settings was evaluated as an applied product due to its central function in the production of chlorophyll and the activation of many plant enzymes that are needed for growth and additionally support protein synthesis. Mg is a secondary macronutrient in which its uptake is generally inhibited to insufficient quantities due to competing nutrients, such as calcium (Ca) and potassium (K) within the soil. Knowing the impact that Mg has on plants, trials were conducted to evaluate the effect of magnesium lactate (MgL) on crops. MgL is a single Mg atom simultaneously bonded to two lactic acid molecules and two water molecules. Corn and soybeans were chosen for this study. MgL was shown to have a positive impact on soybean yield and corn biomass, among other things. In comparison, to conventional magnesium compounds, such magnesium sulfate (MgSO), the MgL used herein performed better overall in the trials.

Materials and Methods: One soybean seed was planted in each of the 60 individually marked pots using six different treatments in a randomized complete block design. Plants were grown in the greenhouse under controlled and ideal conditions. All pots were handled and cared for the same exact way throughout their entire growing season. Several measurements were recorded during this trial starting with emergence hours, the number of plants emerged, and unifoliate, 1^{st} trifoliate, 3^{rd} trifoliate, 5^{th} trifoliate, and 7^{th} trifoliate leaf area readings. Three of the measurements that were recorded when this trial was harvested are the number of pods, weight of pods, total soybean seed weight per treatment, and average soybean seed weight per pot.

The corn trial that was conducted using MgL had one corn seed planted in each of the 60 individually marked pots using six different treatments in a randomized complete block design. Plants were grown in the greenhouse under controlled and ideal conditions. All pots were handled and cared for the same exact way throughout their entire growing season. During this trial the emergence hours, the number of plants emerged, and plant height measurements were taken at specific plant stages and recorded. Several measurements were documented when the trial was harvested which were V10 plant height, V10 chlorophyll readings, stalk diameter, and biomass.

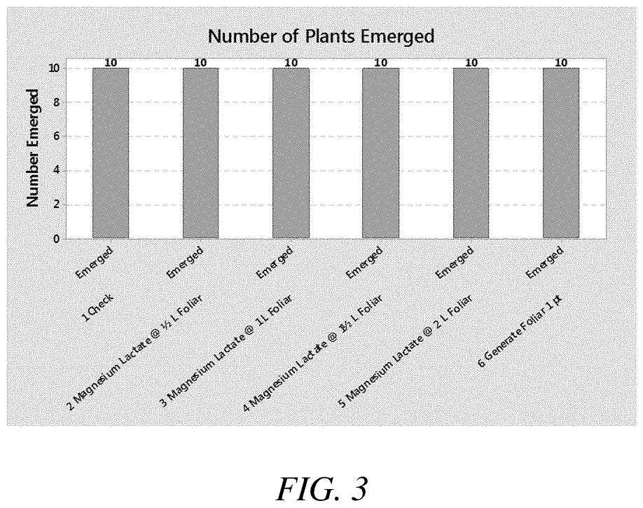

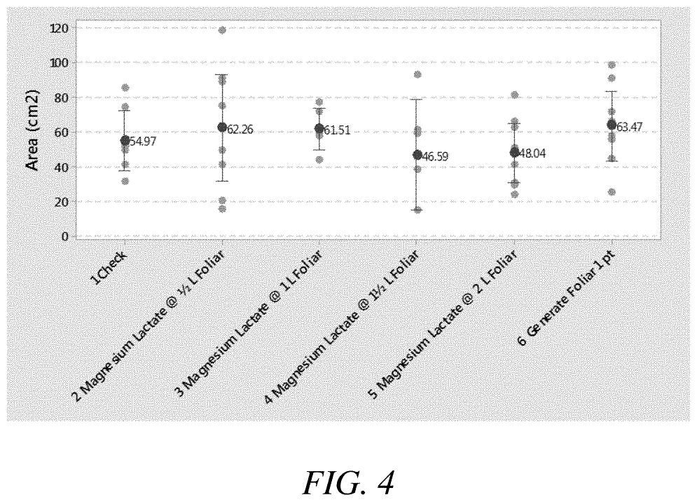

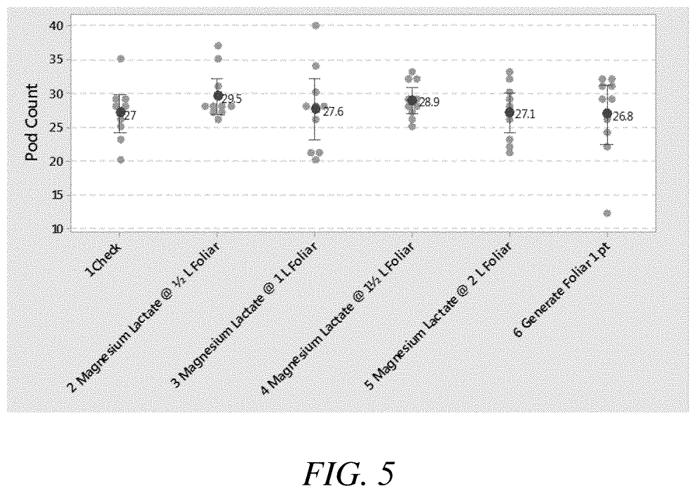

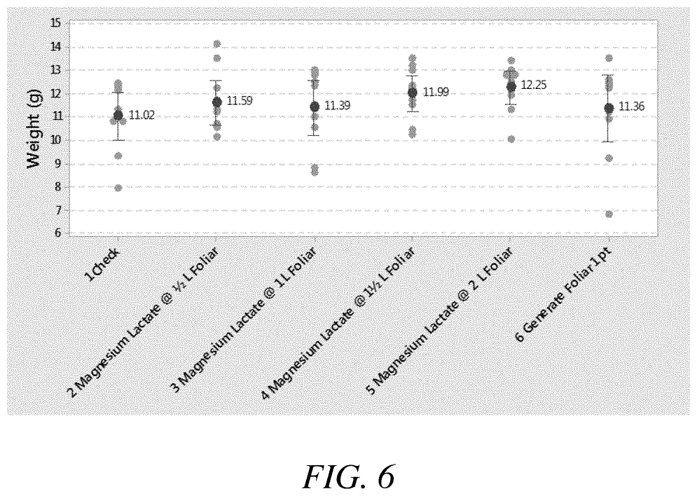

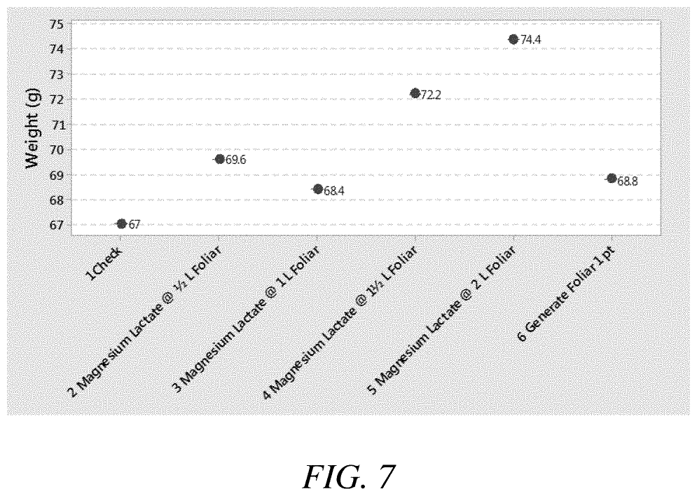

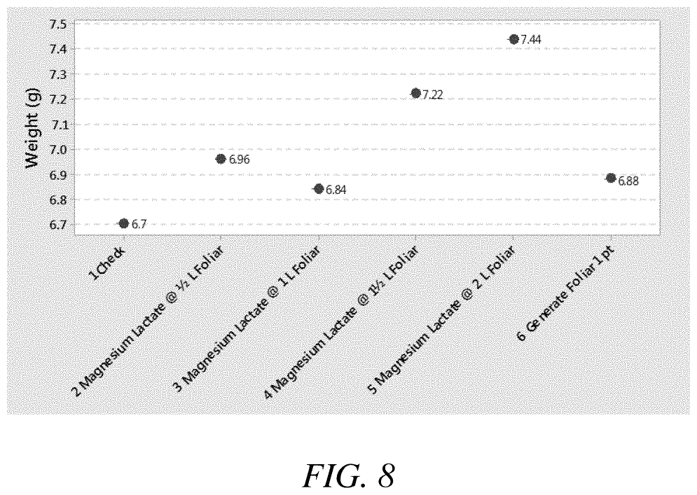

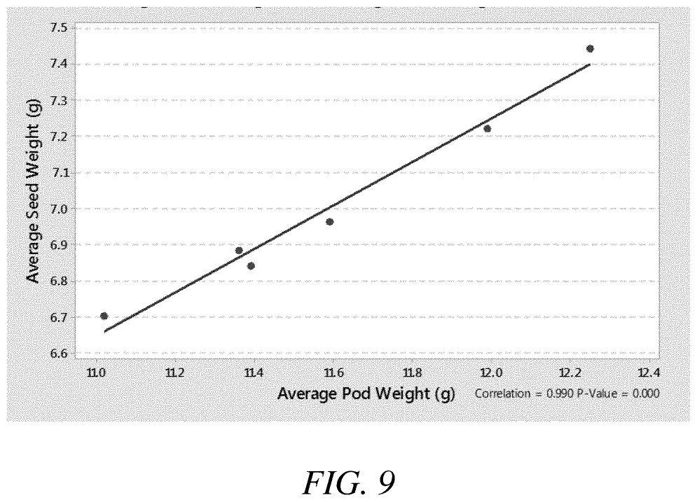

Soybean Results: The MgL had a positive impact on the soybean yield, shown in FIG. 8, which displays the average soybean seed weight per pot. Other results are shown in FIGS. 3-9. The magnesium lactate improved the efficiency with which the plant builds chlorophyll when it was applied foliar in sparingly small quantities to soybean plants early in their growth stage.

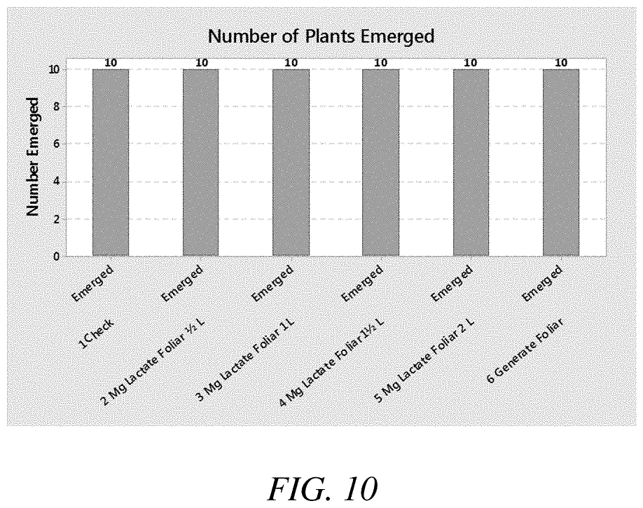

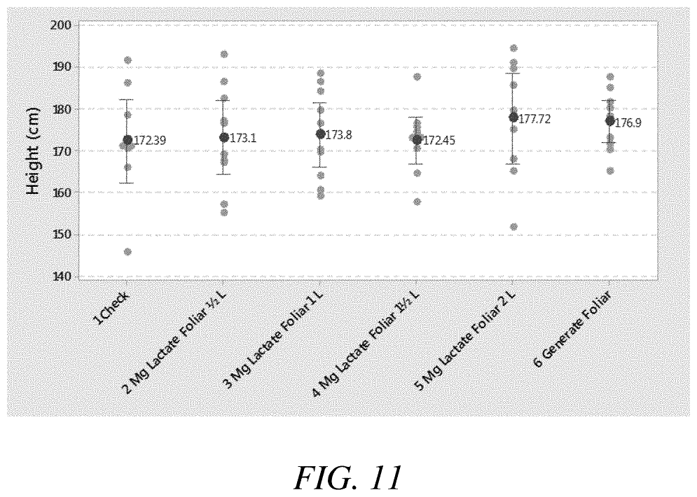

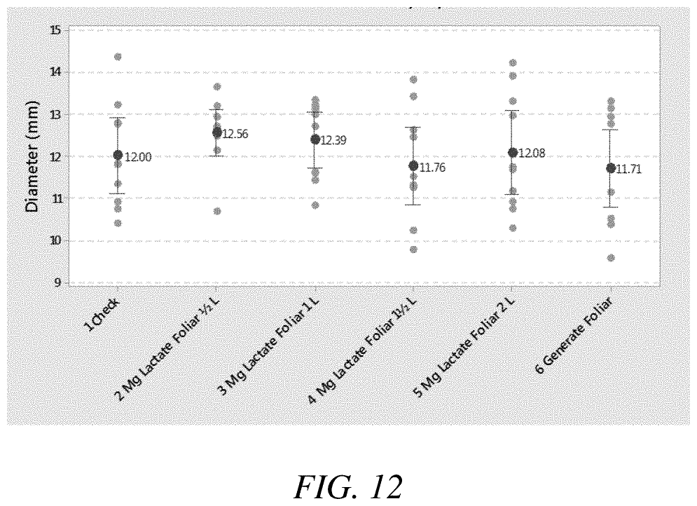

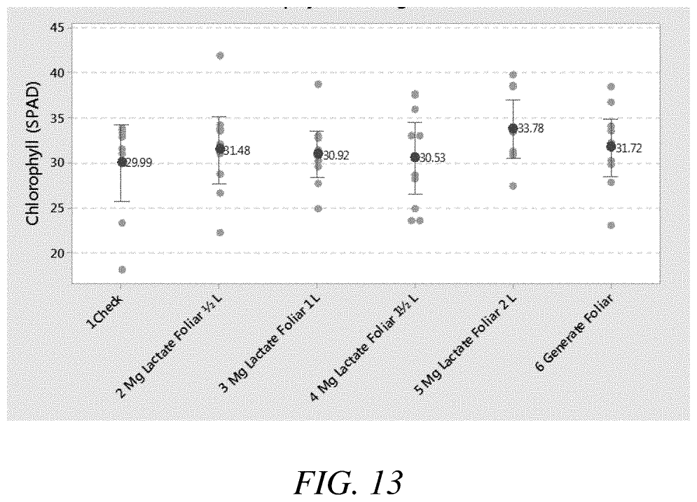

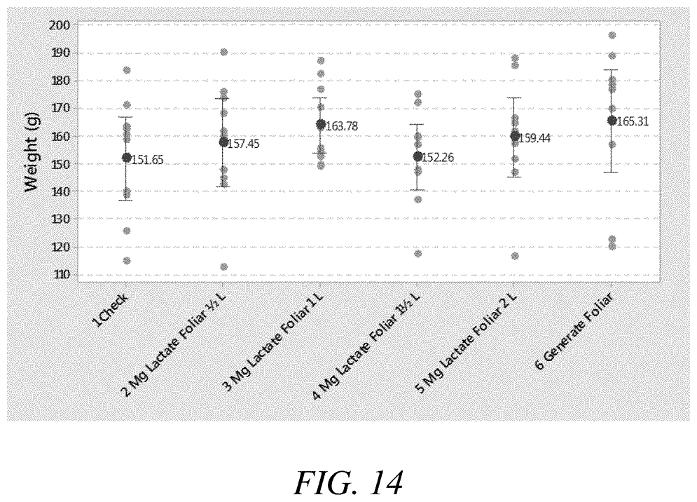

Corn Results: The MgL had a positive impact on corn biomass, and the growth and development of corn, shown in FIG. 14. Results are shown in FIGS. 10-14.

### Example 2

### Magnesium Lactate Applied to Foliar (Corn)

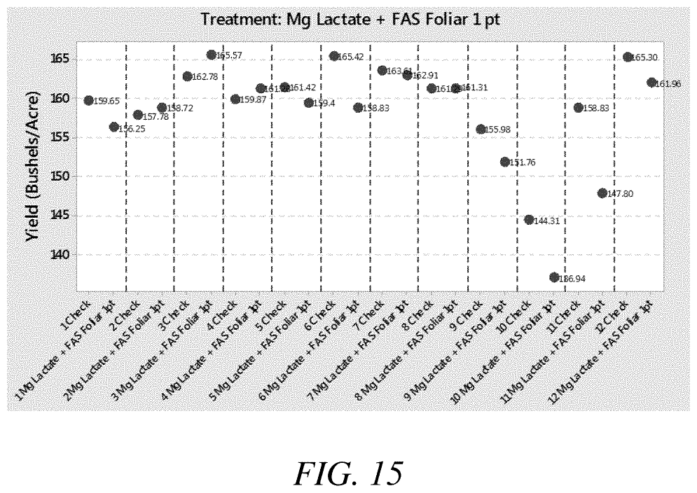

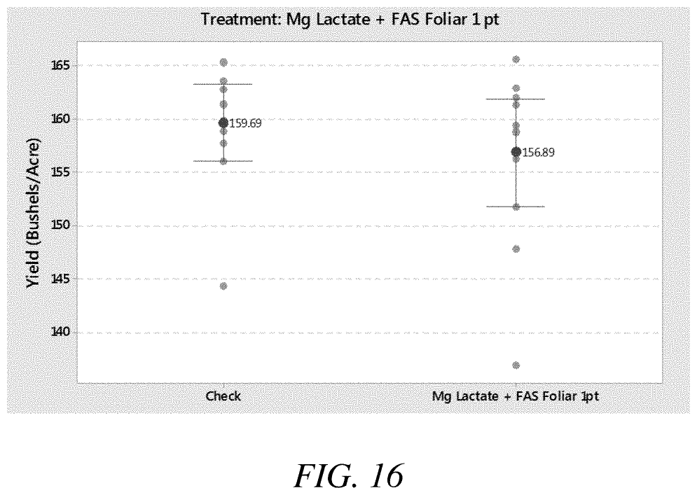

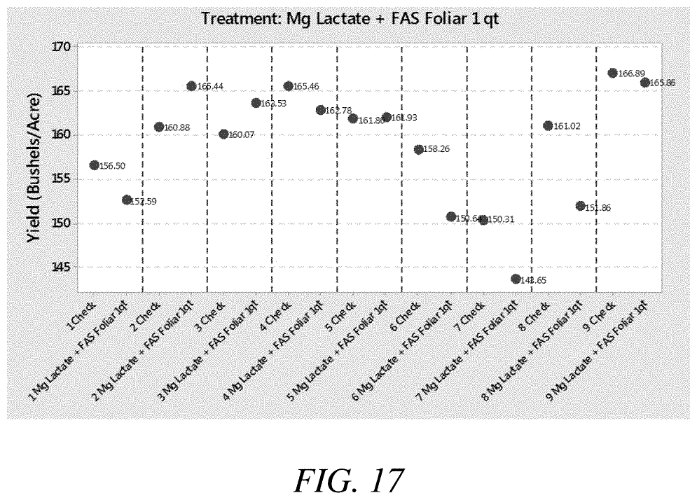

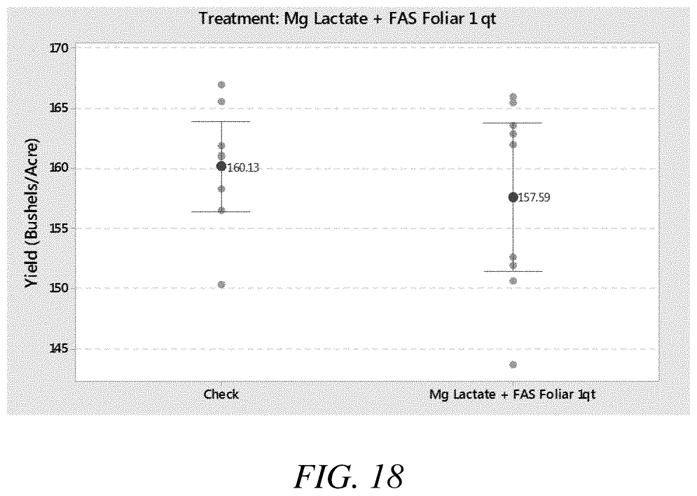

Treatment compositions comprising magnesium lactate, among other things, were applied to foliar in corn studies. The yield results from those applications are shown in FIGS. 15-18 against a check or control. FIG. 15 is a graphical view of yield results from corn studies in which magnesium lactate was applied to foliar, according to one or more embodiments of the present invention. FIG. 16 is a graphical view of yield results from corn studies in which magnesium lactate was applied to foliar, according to one or more embodiments of the present invention. FIG. 17 is a graphical view of yield results from corn studies in which magnesium lactate was applied to foliar, according to one or more embodiments of the present invention. FIG. 18 is a graphical view of yield results from corn studies in which magnesium lactate was applied to foliar, according to one or more embodiments of the present invention.

### Example 3

### Magnesium Lactate Applied in-Furrow (Soybeans)

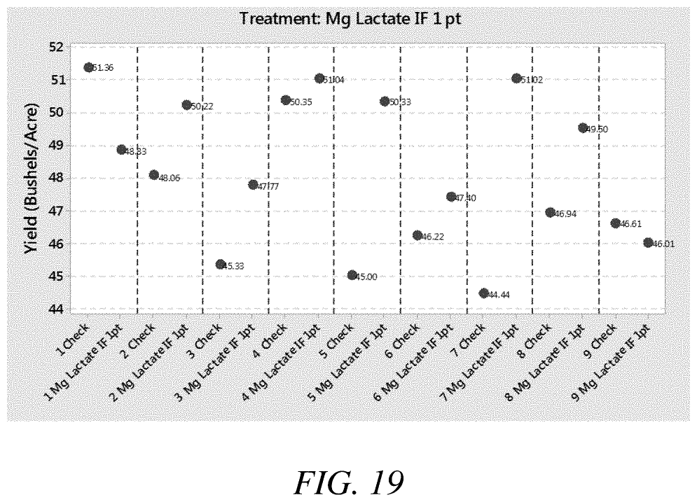

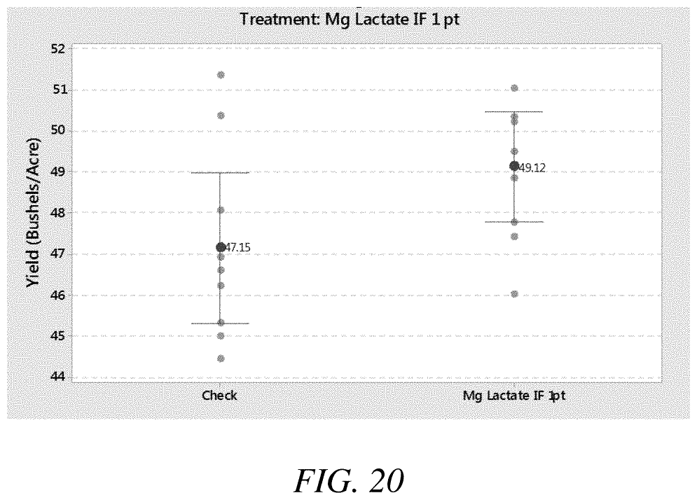

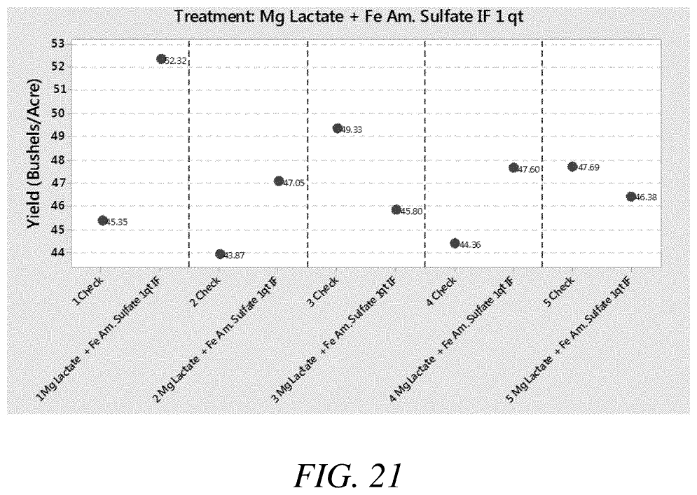

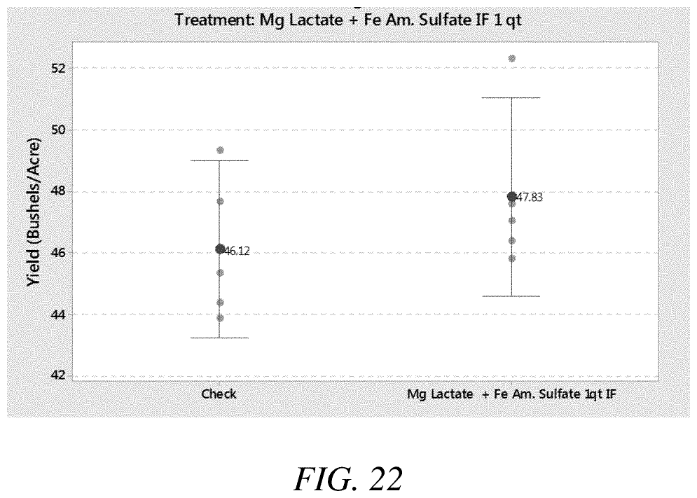

Treatment compositions comprising magnesium lactate, among other things, were applied in furrow in soybean studies. The yield results from those applications are shown in FIGS. 19-22 against a check or control. FIG. 19 is a graphical view of yield results from a second soybean study in which magnesium lactate was applied in furrow, according to one or more embodiments of the present invention. FIG. 20 is a graphical view of yield results from a second soybean study in which magnesium lactate was applied in furrow, according to one or more embodiments of the present invention. FIG. 21 is a graphical view of yield results from a second soybean study in which magnesium lactate was applied in furrow, according to one or more embodiments of the present invention. FIG. 22 is a graphical view of yield results from a second soybean study in which magnesium lactate was applied in furrow, according to one or more embodiments of the present invention.

### Example 4

### Magnesium Lactate Applied to Foliar (Soybean)

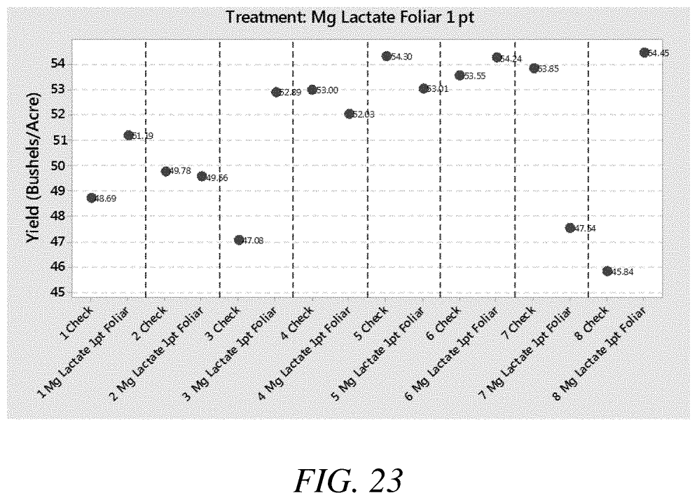

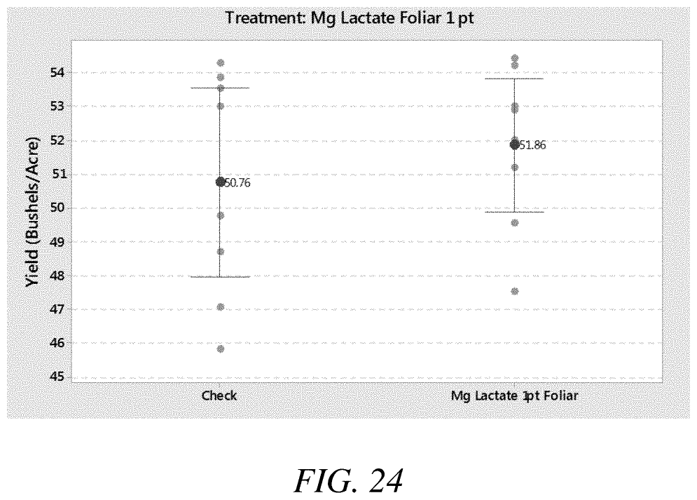

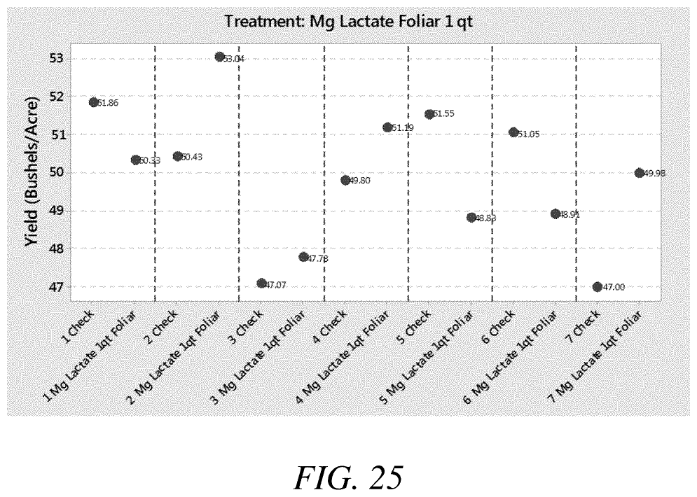

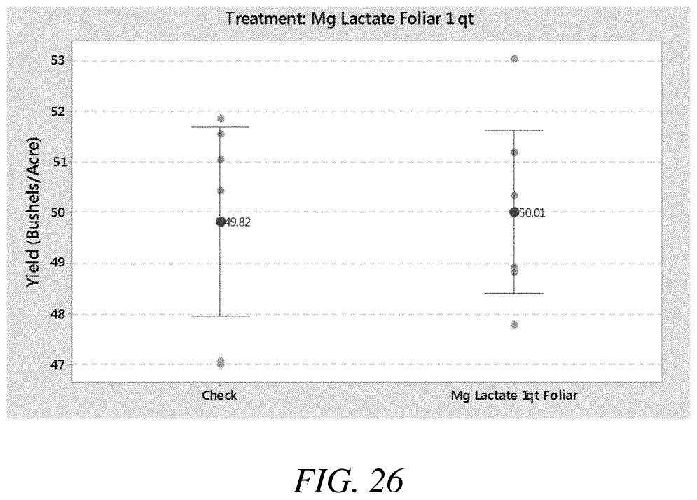

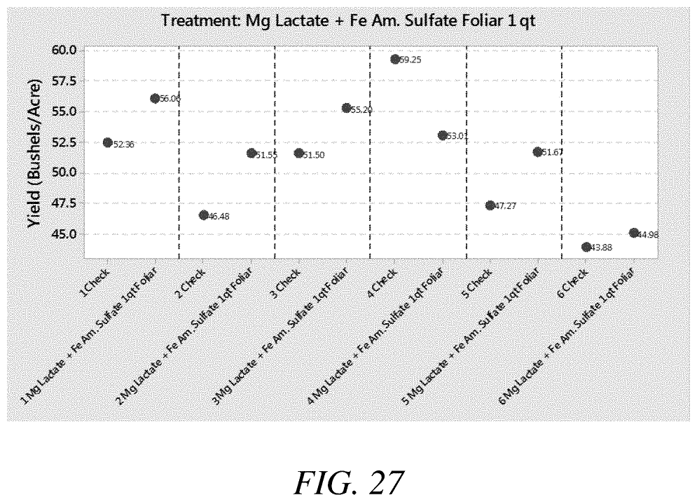

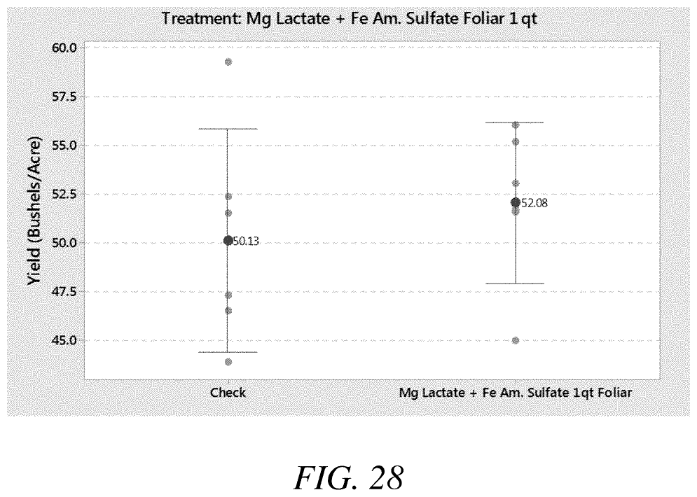

Treatment compositions comprising magnesium lactate, among other things, were applied to foliar in soybean studies. The yield results from those applications are shown in FIGS. 23-28 against a check or control. FIG. 23 is a graphical view of yield results from a third soybean study in which magnesium lactate was applied to foliar, according to one or more embodiments of the present invention. FIG. 24 is a graphical view of yield results from a third soybean study in which magnesium lactate was applied to foliar, according to one or more embodiments of the present invention. FIG. 25 is a graphical view of yield results from a third soybean study in which magnesium lactate was applied to foliar, according to one or more embodiments of the present invention. FIG. 26 is a graphical view of yield results from a third soybean study in which magnesium lactate was applied to foliar, according to one or more embodiments of the present invention. FIG. 27 is a graphical view of yield results from a third soybean study in which magnesium lactate was applied to foliar, according to one or more embodiments of the present invention. FIG. 28 is a graphical view of yield results from a third soybean study in which magnesium lactate was applied to foliar, according to one or more embodiments of the present invention.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

What is claimed is:

1. A seed, soil, or plant treatment composition, comprising:
a macronutrient source consisting of a solid mineral lactate, wherein the mineral lactate is selected from magnesium lactate, calcium lactate, potassium lactate, and ammonium lactate.

2. The composition of claim 1, further comprising a solid carrier, wherein the solid mineral lactate sorbs onto the solid carrier.

3. The composition of claim 2, wherein the solid carrier is selected from diatomaceous earth, limestone, magnesium carbonate, sucrose, maltose, maltodextrin, and dextrose.

4. The composition of claim 1, further comprising a liquid carrier, wherein the solid mineral lactate dissolves in the liquid carrier.

5. The composition of claim 4, wherein the liquid carrier is water.

6. The composition of claim 1, further comprising one or more of mineral chelated compounds, mineral salt compounds, fibers, enzymes, pesticides, insecticides, fungicides, and herbicides.

7. A method of synthesizing a solid mineral lactate, comprising:
providing a solution of lactic acid in a first vessel, wherein the solution is provided at or below a threshold temperature;
contacting the solution of lactic acid with a mineral precursor to form a reaction solution in which at least a portion of the mineral precursor is dissolved; and
allowing the reaction to proceed or transferring the reaction solution to a second vessel where the reaction is allowed to proceed.

8. The method of claim 7, further comprising reducing the solid mineral lactate to a select particle size.

9. The method of claim 7, wherein the select particle size is about 300 μm or less.

10. The method of claim 7, wherein the solution of lactic acid is provided at about 40° F. or less.

11. The method of claim 7, wherein a molar ratio of the lactic acid to the mineral precursor is about 2:1.

12. The method of claim 7, wherein the mineral precursor includes one or more of magnesium, calcium, potassium, and nitrogen.

13. The method of claim 7, wherein the mineral precursor is at least about 90% pure.

14. The method of claim 7, wherein the transferring proceeds while the reaction solution is at or below the threshold temperature.

15. The method of claim 7, wherein the reaction proceeds without producing any waste or byproducts, other than water vapor and/or steam.

16. A method of applying a treatment composition, comprising:
applying a treatment composition to a seed, soil, or plant, wherein the treatment composition comprises a macronutrient source consisting of a solid mineral lactate, wherein the mineral lactate is selected from magnesium lactate, calcium lactate, potassium lactate, and ammonium lactate.

17. The method of claim 16, wherein the treatment composition further comprises one or more of carriers, mineral chelated compounds, mineral salt compounds, fibers, enzymes, pesticides, insecticides, fungicides, and herbicides.

18. The method of claim 16, wherein the applying includes applying to foliar.

19. The method of claim 16, wherein the applying includes applying in-furrow.

20. The method of claim 16, wherein the applying includes applying to seeds.
